(19) United States
(12) Patent Application Publication
(10) Pub. No.: US 2025/0342345 A1
(43) Pub. Date: Nov. 6, 2025

(54) CONTINUOUS UPDATE OF DRIVING SYSTEM FOR INCIDENT AVOIDANCE

(71) Applicant: TOYOTA JIDOSHA KABUSHIKI KAISHA, Aichi-ken (JP)

(72) Inventor: Daisuke HASHIMOTO, Chofu-shi (JP)

(21) Appl. No.: 18/652,777

(22) Filed: May 1, 2024

(51) Int. Cl. G06N 3/0455

(52) U.S. Cl. CPC G06N 3/0455

(57) ABSTRACT

Continuous update of driving system for incident avoidance is performed by collecting a plurality of incident samples from an Internet, the plurality of incident samples identified by an identification machine-learning model to involve one or more vehicles, clustering, by a clustering machine-learning model, the plurality of incident samples into a plurality of incident clusters, and defining, by a requirement defining machine-learning model, a vehicle application compliance requirement according to an incident cluster among the plurality of incident clusters.

### BACKGROUND

Requirement as Code (RaC) is utilized to define the requirements of vehicle applications. RaC encompasses various types of information including requirements that define features and behavior of a vehicle application, metrics and their criteria used to ascertain whether requirements have been met, conditions under which these metrics and criteria are evaluated, and data or test scenarios used for such evaluation.

Creating an RaC file involves taking into account functional and non-functional requirements of a vehicle application and the applicable vehicle, specifications of the vehicle application, including user-valued features, edge cases to consider during testing, and any issues that have been identified for tracking with regression testing.

RaC files are used to test the vehicle applications and the machine learning models they employ to determine whether the requirements have been met, and judge whether the testing criteria have been fulfilled.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for continuous update of driving system for incident avoidance, according to at least some embodiments of the subject disclosure.

FIG. 2 is a schematic diagram of a generator, according to at least some embodiments of the subject disclosure.

FIG. 3 is a schematic diagram of a model updater, according to at least some embodiments of the subject disclosure.

FIG. 4 is a schematic diagram of a vehicle, according to at least some embodiments of the subject disclosure.

FIG. 5 is an operational flow for continuous update of driving system for incident avoidance, according to at least some embodiments of the subject disclosure.

FIG. 6 is an operational flow for requirement generation, according to at least some embodiments of the subject disclosure.

FIG. 7 is an operational flow for model training, according to at least some embodiments of the subject disclosure.

FIG. 8 is an operational flow for vehicle operation, according to at least some embodiments of the subject disclosure.

FIG. 9 is a schematic diagram of a requirement file, according to at least some embodiments of the subject disclosure.

FIG. 10 is a block diagram of a hardware configuration for continuous update of driving system for incident avoidance, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Vehicle applications and the machine learning models thereof are not always updated in a timely manner to resolve new issues, which may be in the form of challenges, weaknesses, or edge cases, because updating requires developers to be notified of new issues and to manually write requirements and design testing accordingly to resolve each issue.

In at least some embodiments of the subject disclosure, in order to update vehicle applications and the machine learning models thereof, incident samples are collected from the Internet using an identification machine-learning model, clustered by a clustering machine-learning model, and used as the basis for defining vehicle application compliance requirements by a requirement defining machine-learning model. In at least some embodiments, the requirement defining machine-learning model defines rules for annotating sensor samples for use as training samples.

In at least some embodiments, incident samples are collected from the Internet using a collection machine-learning (ML) model. In at least some embodiments, the incident samples are clustered by a clustering ML model. In at least some embodiments, requirements are defined for an incident cluster using a requirement defining ML model.

By automatically generating requirements from information collected from the Internet, at least some embodiments continuously update vehicle applications and machine learning models thereof for incident avoidance without developer notification or manual input. By automatically defining annotation rules according to the requirement, at least some embodiments automatically prepare training samples.

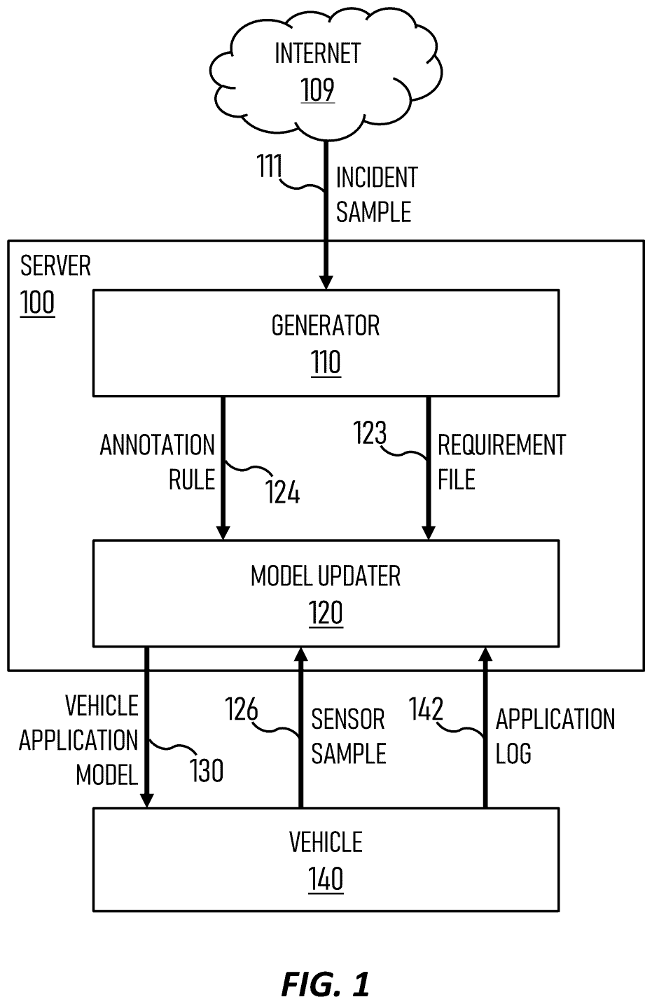

FIG. 1 is a schematic diagram of a system for continuous update of driving system for incident avoidance, according to at least some embodiments of the subject disclosure. The system includes a server 100, an Internet 109, and a vehicle 140.

Server 100 is in communication with Internet 109 and vehicle 140, and includes generator 110, and model updater 120. In at least some embodiments, server 100 is configured to host the machine learning models and process the data for continuous update of driving system for incident avoidance. In at least some embodiments, server 100 is configured to communicate with vehicle 140 to exchange data and updates. In at least some embodiments, server 100 is configured to perform general server tasks such as data storage and network management. In at least some embodiments, server 100 is configured to connect to Internet 109 for data collection and distribution. In at least some embodiments, server 100 comprises multiple physical servers and computing resources. In at least some embodiments, server 100 is a physical server in a data center or a virtual server in the cloud. In at least some embodiments, server 100 is of the type used in many fields, from web hosting to database management.

Generator 110 retrieves incident sample 111 from Internet 109, and transmits requirement files, such as requirement file 123, and annotation rules, such as annotation rule 124, to model updater 120. In at least some embodiments, generator 110 is configured to generate requirement files and annotation rules from incident samples. In at least some embodiments, generator 110 is configured to generate many types of requirement files based on different types of vehicle applications and machine learning models thereof. In at least some embodiments, generator 110 is a software module running on server 100. In at least some embodiments, generator 110 is one of many servers that comprise server 100.

Model updater 120 receives requirement files, such as requirement file 123, and annotation rules, such as annotation rule 124, from generator 110, receives sensor samples, such as sensor sample 126, and application logs, such as application log 142, from vehicle 140, and transmits vehicle application models, such as vehicle application machine-learning model 130, to vehicle 140. In at least some embodiments, model updater 120 is configured to update vehicle application machine-learning model 130 based on training samples prepared and test vehicle application machine-learning model 130 according to vehicle application compliance requirements, such as in requirement file 123. In at least some embodiments, model updater 120 is configured to update other types of machine learning models. In at least some embodiments, model updater 120 is a software module running on server 100. In at least some embodiments, model updater 120 is one of many servers that comprise server 100.

Vehicle 140 receives vehicle application models, such as vehicle application machine-learning model 130, from model updater 120, and transmits sensor samples, such as sensor sample 126, and application logs, such as application log 142, to model updater 120. In at least some embodiments, vehicle 140 is configured to deploy an updated version of vehicle application machine-learning model 130 and generate an application log 142 based on the output of vehicle application machine-learning model 130. In at least some embodiments, vehicle 140 is configured to perform regular vehicle functions, such as transportation. In at least some embodiments, vehicle 140 is configured to interact with the physical world through sensors and actuators. In at least some embodiments, vehicle 140 is any vehicle equipped with a compatible system, such as a car, a truck, a boat, an airplane, a submarine, etc.

Internet 109 is in communication with server 100. In at least some embodiments, Internet 109 is configured to provide a source of incident samples, such as incident sample 111 for the system. In at least some embodiments, Internet 109 is configured to communicate with server 100 to exchange data. In at least some embodiments, Internet 109 is configured to provide a network for various other applications. In at least some embodiments, Internet 109 is configured to connect various systems and devices worldwide. In at least some embodiments, Internet 109 is the global network of networks. In at least some embodiments, Internet 109 is used for a wide range of applications, from communication to entertainment.

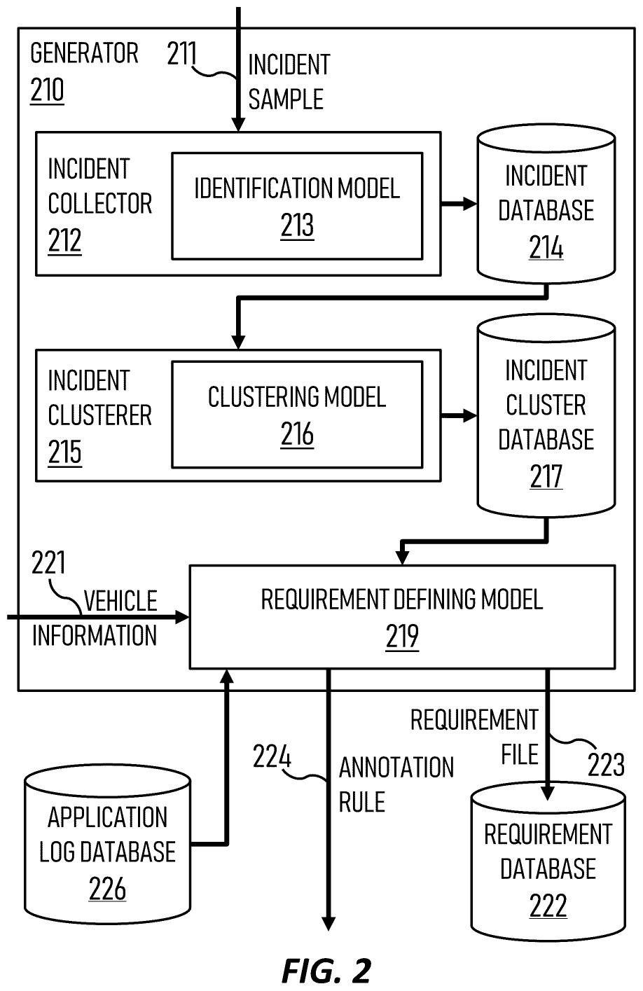

FIG. 2 is a schematic diagram of a generator, according to at least some embodiments of the subject disclosure. Generator 210 includes incident collector 212, incident database 214, incident clusterer 215, incident cluster database 217, and requirement defining model 219. Generator 210 is substantially similar in structure and function to generator 110 of FIG. 1, except where described otherwise.

Incident collector 212 includes identification model 213. In at least some embodiments, incident collector 212 is configured to identify and retrieves incident samples, such as incident sample 211, and stores the incident samples in incident database 214. In at least some embodiments, incident collector 212 is configured to collect incident samples from the Internet. In at least some embodiments, incident samples, such as incident sample 211, are natural language text samples including descriptions of incidents involving one or more vehicles. In at least some embodiments, incident samples, such as incident sample 211, include images. In at least some embodiments, incident samples, such as incident sample 211, include a combination of natural language and image data. In at least some embodiments, incident collector 212 is configured to remove personally identifiable information from incident samples using techniques such as filtering, generalizing, ambiguating, etc. In at least some embodiments, incident collector 212 is configured to replace a specific vehicle identification in an incident sample with a generic description, such as “a large trailer”, “a tanker truck”, etc., as appropriate. In at least some embodiments, incident collector 212 is configured to store the collected incident samples for further processing. In at least some embodiments, incident collector 212 is configured to interact with the Internet to collect incident samples. In at least some embodiments, incident collector 212 is a web crawler or a data scraping tool in real-world forms.

Identification model 213 identifies incident samples for incident collector 212. In at least some embodiments, identification model 213 is configured to identify incident samples that involve one or more vehicles. In at least some embodiments, identification model 213 is configured to process the incident samples collected by incident collector 212. In at least some embodiments, identification model 213 is configured to distinguish other types of data samples from incident samples. In at least some embodiments, identification model 213 is a machine learning model trained to perform a task. In at least some embodiments, identification model 213 is a large language machine-learning model trained for natural language processing.

Incident database 214 receives incident samples from the generator 210 and transmits incident samples to incident clusterer 215. In at least some embodiments, incident database 214 is configured to store the incident samples collected from the Internet. In at least some embodiments, incident database 214 is configured to store other types of data. In at least some embodiments, incident database 214 is a file system, a relational database, a NoSQL database, etc. In at least some embodiments, incident database 214 is of a type are used in many fields, such as data analysis and web development.

Incident clusterer 215 includes clustering model 216. In at least some embodiments, incident clusterer 215 is configured to receive incident samples from incident database 214 and transmit incident clusters to incident cluster database 217. In at least some embodiments, incident clusterer 215 is configured to cluster the incident samples into incident clusters. In at least some embodiments, incident clusterer 215 is configured to cluster many types of data.

Clustering model 216 is used by incident clusterer 215. In at least some embodiments, clustering model 216 is used by incident clusterer 215 to cluster the incident samples. In at least some embodiments, clustering model 216 is a machine learning model trained to perform a clustering task for vehicle incidents. In at least some embodiments, clustering model 216 is of the type used in many fields, such as data mining and market segmentation.

Incident cluster database 217 receives incident clusters from incident clusterer 215 and transmits incident clusters to requirement defining model 219. In at least some embodiments, incident cluster database 217 is configured to store the incident clusters generated by incident clusterer 215. In at least some embodiments, incident cluster database 217 is configured to store other types of data. In at least some embodiments, incident cluster database 217 is a file system, a relational database, a NoSQL database, etc. In at least some embodiments, incident cluster database 217 is of the type used in many fields, such as data analysis and web development.

Requirement defining model 219 receives incident clusters from incident cluster database 217, vehicle information 221, and application logs from application log database 226, and transmits vehicle application compliance requirements to requirement database 222. In at least some embodiments, requirement defining model 219 is configured to define vehicle application compliance requirements, such as in requirement file 223, according to an incident cluster and vehicle information. In at least some embodiments, requirement defining model 219 is configured to define vehicle application compliance requirements, such as in requirement file 223, according to an incident cluster, vehicle information, and application logs. In at least some embodiments, requirement defining model 219 is configured to process the incident clusters stored in incident cluster database 217. In at least some embodiments, requirement defining model 219 is configured to define vehicle application compliance requirements for many types of vehicle applications. In at least some embodiments, requirement defining model 219 is a machine learning model trained to perform a task of RaC defining. In at least some embodiments, requirement defining model 219 is configured to define rules, such as annotation rule 224, for annotating sensor samples for use as training samples.

Vehicle information 221 is utilized by requirement defining model 219. In at least some embodiments, vehicle information 221 is utilized by requirement defining model 219 to tailor vehicle application compliance requirements to a specific vehicle or type of vehicles. In at least some embodiments, vehicle information 221 includes a specification of the vehicle application, a design document of the vehicle application, a source code of the vehicle application, or any combination thereof. In at least some embodiments, vehicle information 221 is configured to provide information about the vehicle for which the vehicle application compliance requirement is being developed. In at least some embodiments, vehicle information 221 is configured to provide information about many types of vehicles. In at least some embodiments, vehicle information 221 is a database or a file containing the vehicle specifications in real-world forms. In at least some embodiments, vehicle information is of the type used in many fields, such as automotive engineering and vehicle manufacturing.

Requirement database 222 receives vehicle application compliance requirements from requirement defining model 219. In at least some embodiments, requirement database 222 is configured to store the vehicle application compliance requirements defined by requirement defining model 219. In at least some embodiments, requirement database 222 is configured to provide these requirements to other components for processing. In at least some embodiments, requirement database 222 is configured to store vehicle application compliance requirements for many types of vehicle applications. In at least some embodiments, requirement database 222 is a file system, a relational database, a NoSQL database, etc.

Requirement file 223 is generated by generator 210. In at least some embodiments, requirement file 223 is configured to contain the vehicle application compliance requirement in a computer-readable format. In at least some embodiments, requirement file 223 is used by other components to understand the vehicle application compliance requirement. In at least some embodiments, requirement file 223 is a text file, a JSON file, an XML file, etc. In at least some embodiments, requirement file 223 is an RaC file, such as those used in software development and project management.

Annotation rule 224 is generated by generator 210. In at least some embodiments, annotation rule 224 is used to label training samples. In at least some embodiments, annotation rule 224 is a set of rules defined in a programming language.

Application log database 226 is in communication with requirement defining model 219. In at least some embodiments, application log database 226 is configured to store output application logs of the vehicle application machine-learning model. In at least some embodiments, application log database 226 is configured to receive application logs from the vehicle. In at least some embodiments, application log database 226 is configured to provide application logs to requirement defining model 219. In at least some embodiments, application log database 226 is configured to store other types of logs. In at least some embodiments, application log database 226 is configured to interact with and provide application logs to other components. In at least some embodiments, application log database 226 is a file system, a relational database, a NoSQL database, etc.

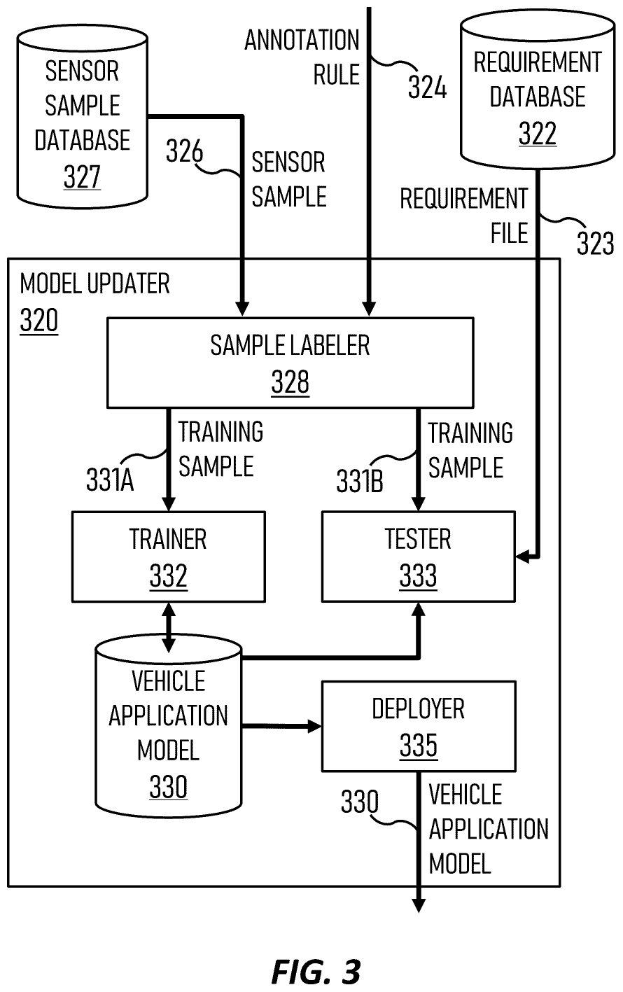

FIG. 3 is a schematic diagram of a model updater, according to at least some embodiments of the subject disclosure. Model updater 320 includes sample labeler 328, vehicle application model 330, training sample 331, trainer 332, tester 333, and deployer 335. Model updater 320 is substantially similar in structure and function to model updater 130 of FIG. 1, except where described otherwise. Requirement database 322, requirement file 323, and annotation rule 324 are each substantially similar in structure and function to requirement database 222, requirement file 223, and annotation rule 224 of FIG. 2, respectively, except where described otherwise.

Sensor sample 326 is a sample of data collected from a sensor. In at least some embodiments, sensor sample 326 is a sample of data collected from a sensor of a vehicle. In at least some embodiments, sensor sample 326 is labeled by sample labeler 328 to become a training sample. In at least some embodiments, sensor sample 326 is in the form of a value, a string, an image, a video, an audio clip, or any other digital format produced by a sensor.

Sensor sample database 327 stores and provides sensor samples, such as sensor sample 326. In at least some embodiments, sensor sample database 327 is configured to store any type of data samples. In at least some embodiments, sensor sample database 327 provides other components with sensor samples.

Sample labeler 328 receives sensor samples from the sensor sample database 327 and annotation rule 324, and provides training samples to trainer 332 and tester 333. In at least some embodiments, sample labeler 328 applies the annotation rule 324 to sensor samples, and provides labeled samples, such as training samples 331A and 331B, to trainer 332 and tester 333, respectively. In at least some embodiments, sample labeler 328 is configured to label sensor samples according to annotation rule 324. In at least some embodiments, sample labeler 328 is configured to label any type of data samples. In at least some embodiments, sample labeler 328 determines which training samples are used for training and which are used for testing. In at least some embodiments, sample labeler 328 is a software module within model updater 320. In at least some embodiments, sample labeler 328 is of the type used in any system that employs supervised machine learning.

Vehicle application machine-learning model 330 is a machine learning model for the vehicle application. In at least some embodiments, vehicle application machine-learning model 330 is trained or updated with training samples, such as training sample 331A. In at least some embodiments, vehicle application machine-learning model 330 is one of many types of autonomous driving models, such as an image classification model, etc. In at least some embodiments, vehicle application machine-learning model 330 is a data structure that encapsulates the parameters of the machine learning model.

Trainer 332 receives training samples, such as training sample 331A, from sample labeler 328, and trains vehicle application machine-learning model 330. In at least some embodiments, trainer 332 is configured to train the vehicle application machine learning model with a portion of the training samples. In at least some embodiments, trainer 332 is configured to update vehicle application machine-learning model 330. In at least some embodiments, trainer 332 is not limited to training vehicle application machine-learning models. In at least some embodiments, trainer 332 is configured to train any machine learning model using supervised training. In at least some embodiments, trainer 332 stores iterations of vehicle application model 330 during training. In at least some embodiments, trainer 332 is a software module within model updater 320.

Tester 333 is configured to receive testing samples, such as training sample 331B, from sample labeler 328. In at least some embodiments, tester 333 is configured to apply the vehicle application machine-learning model 330 to the training samples. In at least some embodiments, tester 333 is configured to test the vehicle application machine learning model with a portion of the training samples. In at least some embodiments, tester 333 is not limited to vehicle application machine learning models. In at least some embodiments, tester 333 is a software module within model updater 320.

Deployer 335 is in communication with vehicle application machine-learning model 330 and the vehicle. In at least some embodiments, deployer 335 is configured to deploy the vehicle application machine learning model to the vehicle. In at least some embodiments, deployer 335 is configured to receive vehicle application machine-learning model 330. In at least some embodiments, deployer 335 deploys vehicle application machine-learning model 330 in response to validation by tester 333. In at least some embodiments, deployer 335 is a software module within model updater 320.

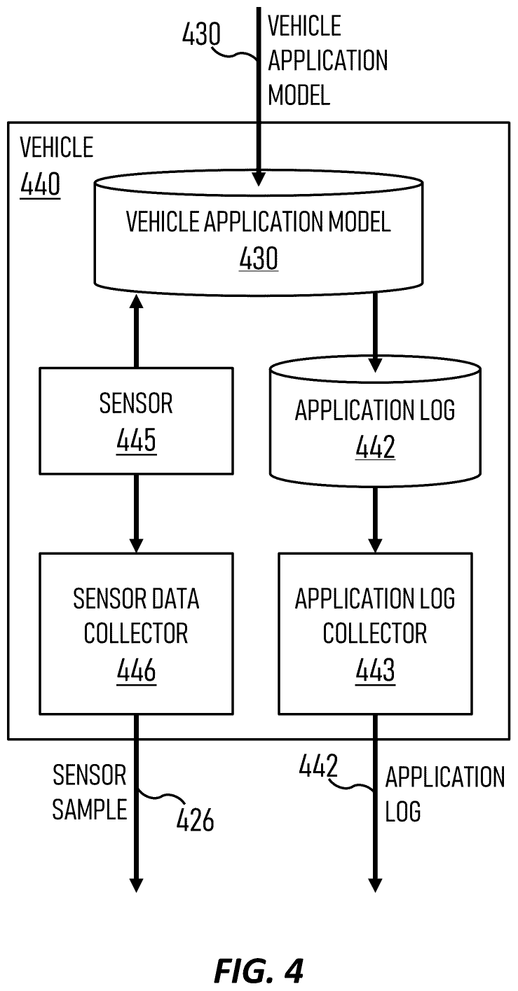

FIG. 4 is a schematic diagram of a vehicle, according to at least some embodiments of the subject disclosure. Vehicle 440 includes vehicle application model 430, application log 442, application log collector 443, sensor 445, and sensor sample collector 446. Vehicle 440 is substantially similar in structure and function to vehicle 140 of FIG. 1, except where described otherwise. Vehicle application machine-learning model 430 and sensor sample 426 are each substantially similar in structure and function to vehicle application machine-learning model 330 and sensor sample 326 of FIG. 3, respectively, except where described otherwise.

Application log 442 is an output log of vehicle application machine-learning model 430. In at least some embodiments, application log 442 includes sequential output of inferences performed by vehicle application model 430. In at least some embodiments, application log 442 is populated with image classification results. In at least some embodiments, application log 442 is a text file, a CSV file, etc.

Application log collector 443 receives application logs, such as application log 442. In at least some embodiments, application log collector 443 is configured to collect application logs output from vehicle application machine-learning model 430. In at least some embodiments, application log collector 443 is configured to interact with vehicle application machine-learning model 430 to facilitate collection. In at least some embodiments, application log collector 443 is a software component of vehicle 440.

Sensor 445 is configured to transmit sensor samples to vehicle application model 430 and sensor data collector 446. In at least some embodiments, sensor 445 is configured to convert real-world stimuli into digital signals and data. In at least some embodiments, sensor 445 is configured to collect real-time data about the vehicle's surroundings. In at least some embodiments, sensor 445 is one of many sensors included in vehicle 440. In at least some embodiments, sensor 445 is a camera, LiDAR, radar, microphone, GPS sensor, accelerometer, thermometer, barometer, etc.

Sensor sample collector 446 is in communication with sensor 445. In at least some embodiments, sensor sample collector 446 is configured to collect sensor samples, such as sensor sample 426, from sensor 445. In at least some embodiments, sensor sample collector 446 is configured to interact with sensor 445. In at least some embodiments, sensor sample collector 446 is also configured to interact with vehicle application machine-learning model 430 to qualify the collected sensor samples. In at least some embodiments, sensor sample collector 446 is a software component within vehicle 440.

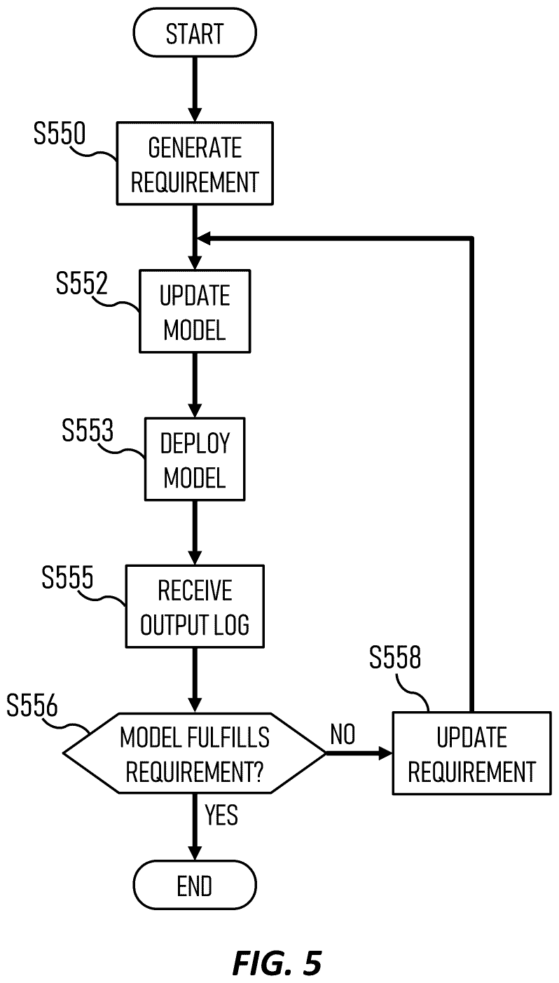

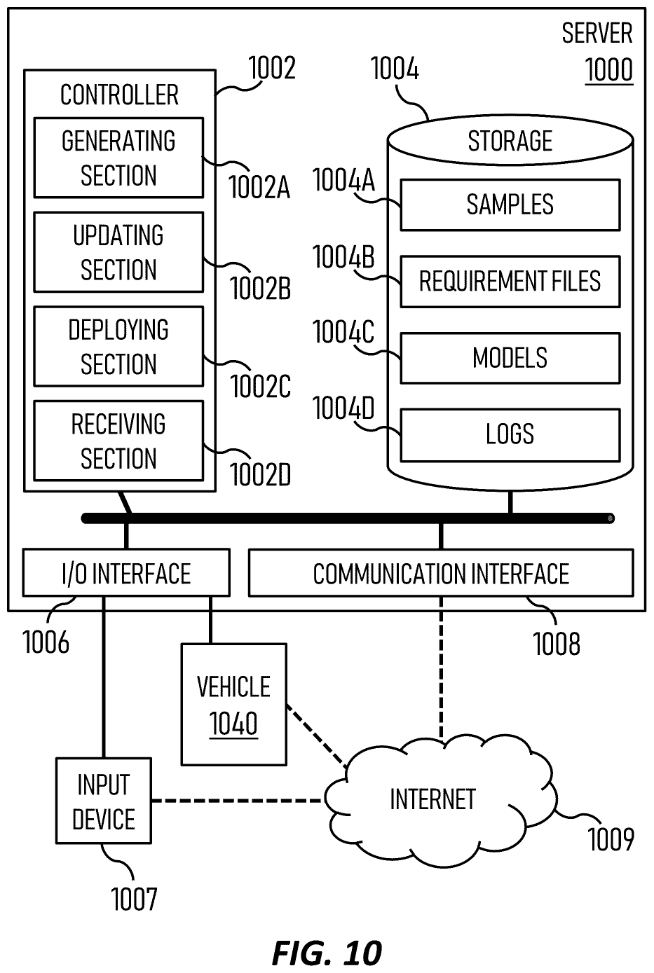

FIG. 5 is an operational flow for continuous update of driving system for incident avoidance, according to at least some embodiments of the subject disclosure. In at least some embodiments, the operational flow provides a method of continuous update of driving system for incident avoidance, according to at least some embodiments of the subject disclosure. In at least some embodiments, the method is performed by a controller of a server, such as controller 1002 of server 1000 of FIG. 10, described hereinafter.

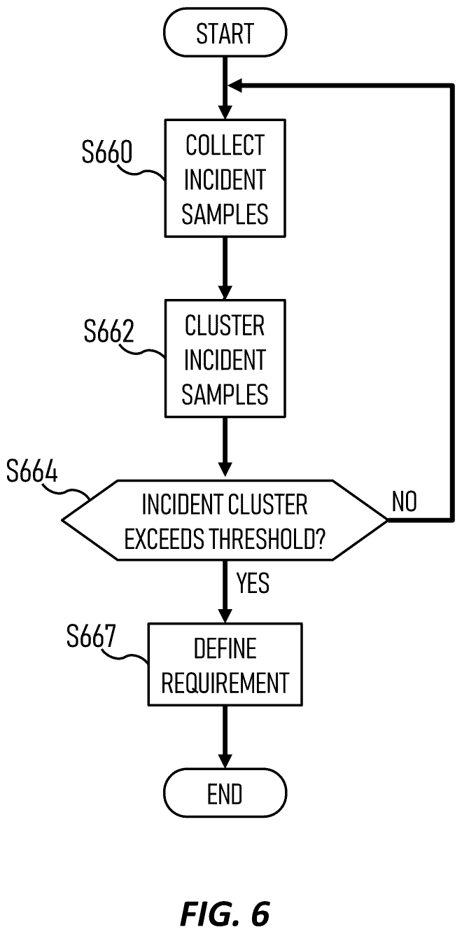

At S550, the controller or a section thereof generates a vehicle application compliance requirement. In at least some embodiments, the controller directs a requirement defining machine-learning model to define a vehicle application compliance requirement based on an incident cluster. In at least some embodiments, the result of this operation by the controller is a defined vehicle application compliance requirement. In at least some embodiments, the controller performs this operation to set a standard that the vehicle application machine-learning model will be trained to meet. In at least some embodiments, the controller performs the operational flow of FIG. 6, explained hereinafter.

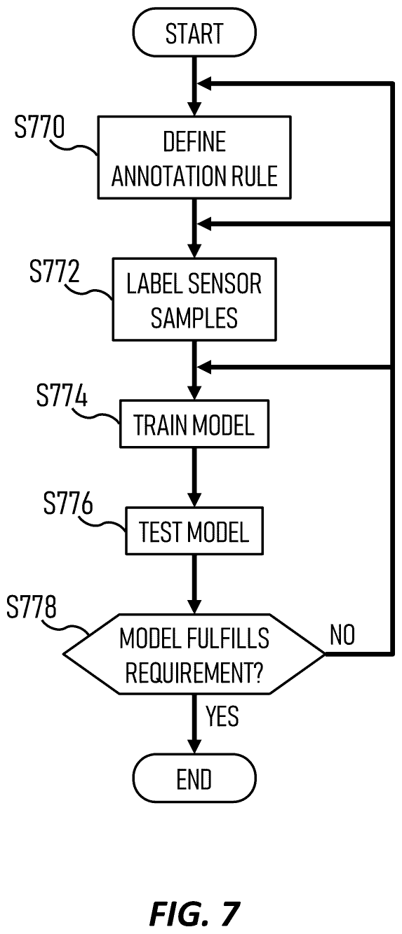

At S552, the controller or a section thereof updates a vehicle application machine-learning model. In at least some embodiments, the controller trains the vehicle application machine-learning model to meet the generated vehicle application compliance requirement. In at least some embodiments, the result of this operation by the controller is an updated version of the vehicle application machine-learning model. In at least some embodiments, the controller performs this operation to improve the performance of the vehicle application machine-learning model based on the latest incidents. In at least some embodiments, the controller performs the operational flow of FIG. 7, explained hereinafter.

At S553, the controller or a section thereof deploys the updated model. In at least some embodiments, the controller deploys the vehicle application machine-learning model to a vehicle. In at least some embodiments, in response to this deployment, the controller directs the vehicle to start using the updated version of the vehicle application machine-learning model. In at least some embodiments, this operation by the controller is performed only if the vehicle application machine-learning model fulfills the vehicle application compliance requirement. In at least some embodiments, the controller performs this operation so that the vehicle system can benefit from the improvements made to the model.

At S555, the controller or a section thereof receives an output log. In at least some embodiments, the controller receives an output log of the vehicle application machine-learning model from the vehicle. In at least some embodiments, in response to receiving the output log, the controller analyzes the output log to validate the vehicle application machine-learning model. In at least some embodiments, this operation requires deployment of the vehicle application machine-learning model to the vehicle.

At S556, the controller or a section thereof determines whether the vehicle application machine-learning model fulfills the vehicle application compliance requirement. In response to the vehicle application machine-learning model not fulfilling the vehicle application compliance requirement, the operational flow proceeds to update the requirement at S558. In response to the vehicle application machine-learning model fulfilling the vehicle application compliance requirement, the operational flow ends. In at least some embodiments, the controller performs this operation to verify that the vehicle application machine-learning model continues to fulfill the vehicle application compliance requirement even after deployment.

At S558, the controller updates the vehicle application compliance requirement. After updating the requirement, the operational flow returns to update the model at S552. In at least some embodiments, the controller updates the vehicle application compliance requirement according to a result of application log analysis. In at least some embodiments, in response to updating the requirement, the controller updates the vehicle application machine-learning model again based on the updated requirement.

FIG. 6 is an operational flow for requirement generation, according to at least some embodiments of the subject disclosure. In at least some embodiments, the operational flow provides a method of requirement generation, according to at least some embodiments of the subject disclosure. In at least some embodiments, the method is performed by a controller of a server, such as controller 1002 of server 1000 of FIG. 10, described hereinafter.

At S660, the controller or a section thereof collects incident samples. In at least some embodiments, the controller utilizes an identification machine-learning model to gather incident samples from the Internet. In at least some embodiments, the controller collects various incident samples involving one or more vehicles. In at least some embodiments, the controller causes the identification machine-learning model to interact with various data sources on the Internet, such as web news articles, web pages, X (Twitter), Facebook, Instagram, TikTok, or any other Internet content. In at least some embodiments, the controller accumulates incident samples in an incident database.

At S662, the controller or a section thereof clusters incident samples. In at least some embodiments, the controller uses a clustering machine-learning model to organize the collected incident samples into several incident clusters. In at least some embodiments, this operation causes changes in the organization and categorization of the incident samples through the clustering machine-learning model. In at least some embodiments, the controller forms a set, or cluster, of incident samples. In at least some embodiments, the controller causes the cluster machine-learning model to identify patterns and trends in the incident samples.

At S664, the controller or a section thereof determines whether the incident cluster exceeds the threshold. In response to the condition not being met, the operational flow returns to collecting incident samples at S660. In response to the condition being met, the operational flow proceeds to defining vehicle application compliance requirement at S667. In at least some embodiments, the controller determines whether a priority value assigned to an incident cluster exceeds a threshold priority value. In at least some embodiments, the priority value relates to a number of incident samples in the incident cluster. In at least some embodiments, the controller compares the priority value of the incident cluster with the threshold priority value. In at least some embodiments, the controller ensures that only significant incident clusters, as determined by the threshold priority value, are used in defining vehicle application compliance requirements.

At S667, the controller or a section thereof defines vehicle application compliance requirement. In at least some embodiments, the controller utilizes a requirement defining machine-learning model to produce a vehicle application compliance requirement based on an incident cluster among multiple incident clusters. In at least some embodiments, the controller applies the requirement defining machine-learning model to incident samples in the incident cluster, vehicle information, and sensor samples to produce the vehicle application compliance requirement.

FIG. 7 is an operational flow for model training, according to at least some embodiments of the subject disclosure. In at least some embodiments, the operational flow provides a method of model training, according to at least some embodiments of the subject disclosure. In at least some embodiments, the method is performed by a controller of a server, such as controller 1002 of server 1000 of FIG. 10, described hereinafter.

At S770, the controller or a section thereof defines annotation rules. In at least some embodiments, the controller creates a set of guidelines or rules. In at least some embodiments, these rules determine how sensor samples should be labeled or annotated. In at least some embodiments, the controller utilizes the requirement defining machine-learning model to produce the annotation rule for annotating sensor samples for supervised training to comply with the vehicle application compliance requirement. In at least some embodiments, the controller defines the annotation rules for consistent and accurate labeling of sensor samples.

At S772, the controller or a section thereof labels sensor samples. In at least some embodiments, the controller applies one or more annotation rules for annotating sensor samples for supervised training to comply with the vehicle application compliance requirement. In at least some embodiments, the controller retrieves available sensor samples from a sensor sample database. In at least some embodiments, the controller produces a training set of labeled sensor samples based on the annotation rule. In at least some embodiments, the annotation rule enables the controller to produce training samples without human intervention.

At S774, the controller or a section thereof trains the model. In at least some embodiments, the controller trains the vehicle application machine learning model. In at least some embodiments, the controller adjusts weights and biases of the vehicle application machine learning model in response to correct or incorrect output. In at least some embodiments, the controller uses a portion of the labeled sensor samples for training. In at least some embodiments, the controller divides a set of training samples into a portion used for training and a portion used for testing. In at least some embodiments, the controller performs several iterations of training to produce a trained machine learning model.

At S776, the controller or a section thereof tests the model. In at least some embodiments, the controller tests the trained vehicle application machine learning model. In at least some embodiments, the controller uses a different portion of the labeled sensor samples for testing. In at least some embodiments, the controller applies the model to training samples within the scope of a metric condition specified in a requirement file of the vehicle application compliance requirement. In at least some embodiments, the controller evaluates the performance of the vehicle application machine learning model. In at least some embodiments, the controller produces a performance evaluation of the vehicle application machine learning model.

At S778, the controller or a section thereof determines whether the model fulfills the requirement. In response to the model not fulfilling the requirement, the operational flow returns to one of training the model at S774, labeling sensor samples at S772, and defining annotation rules at S770. In response to the model fulfilling the requirement, the operational flow ends. In at least some embodiments, the controller determines whether performance of the vehicle application machine learning model meets the vehicle application compliance requirement. In at least some embodiments, the controller determines whether the model fulfills the metric criteria specified in a requirement file of the vehicle application compliance requirement. In at least some embodiments, in response to the vehicle application machine learning model fulfilling the vehicle application compliance requirement, the controller deploys the vehicle application machine learning model. In at least some embodiments, in response to the vehicle application machine learning model not fulfilling the requirement, the controller determines whether to modify the vehicle application compliance requirement, prepare more training samples, or retrain the vehicle application machine learning model.

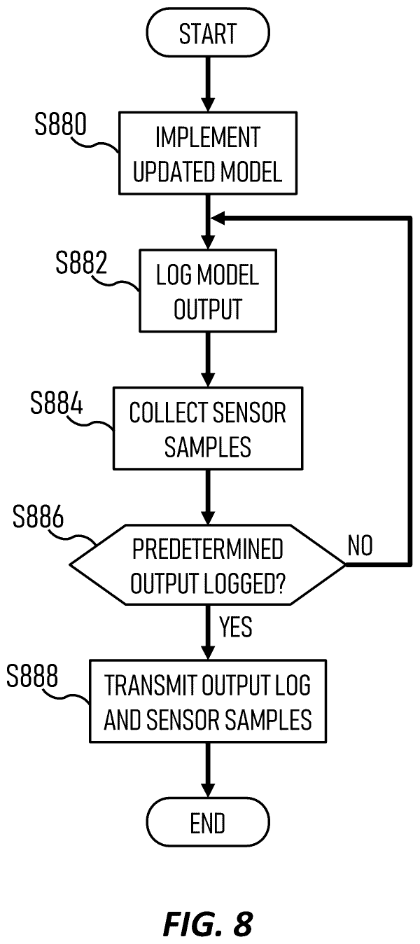

FIG. 8 is an operational flow for vehicle operation, according to at least some embodiments of the subject disclosure. In at least some embodiments, the operational flow provides a method of vehicle operation, according to at least some embodiments of the subject disclosure. In at least some embodiments, the method is performed by a controller of a vehicle, such as an electronic controller unit (ECU) of vehicle 1040 of FIG. 10, described hereinafter.

At S880, the controller implements the updated model. In at least some embodiments, the controller implements the updated version of the vehicle application machine-learning model. In at least some embodiments, the controller initiates the use of the updated model in the vehicle. In at least some embodiments, the vehicle starts using the updated model for live operations. In at least some embodiments, the controller causes the vehicle to use the most recent and accurate version of the vehicle application machine-learning model.

At S882, the controller logs the model output. In at least some embodiments, the controller records applications log of the output of the vehicle application machine-learning model. In at least some embodiments, the log can be used for analysis and validation.

At S884, the controller collects sensor samples. In at least some embodiments, the controller collects sensor samples from one or more sensors in the vehicle. In at least some embodiments, the controller generates a set of sensor samples. In at least some embodiments, the controller preserves sufficient quality and resolution of the sensor samples for training and testing the vehicle application machine-learning model.

At S886, the controller determines whether a predetermined output has been logged. In response to the predetermined output not being logged, the operational flow returns to logging the model output at S882. In response to the predetermined output being logged, the operational flow proceeds to transmitting the output log and sensor samples at S888. In at least some embodiments, the predetermined output is a classification of a scene to be avoided according to a vehicle application compliance requirement.

At S888, the controller transmits the output log and sensor samples. In at least some embodiments, the controller transmits the output log and sensor samples. In at least some embodiments, this operation sends the collected data to a location. In at least some embodiments, the location is where the data can be analyzed and used to update the model. In at least some embodiments, the predetermined output is logged, and sensor samples are collected. In at least some embodiments, the output log and sensor samples are sent for further processing. In at least some embodiments, transmitting the data allows for further analysis and validation, which is necessary for updating the model.

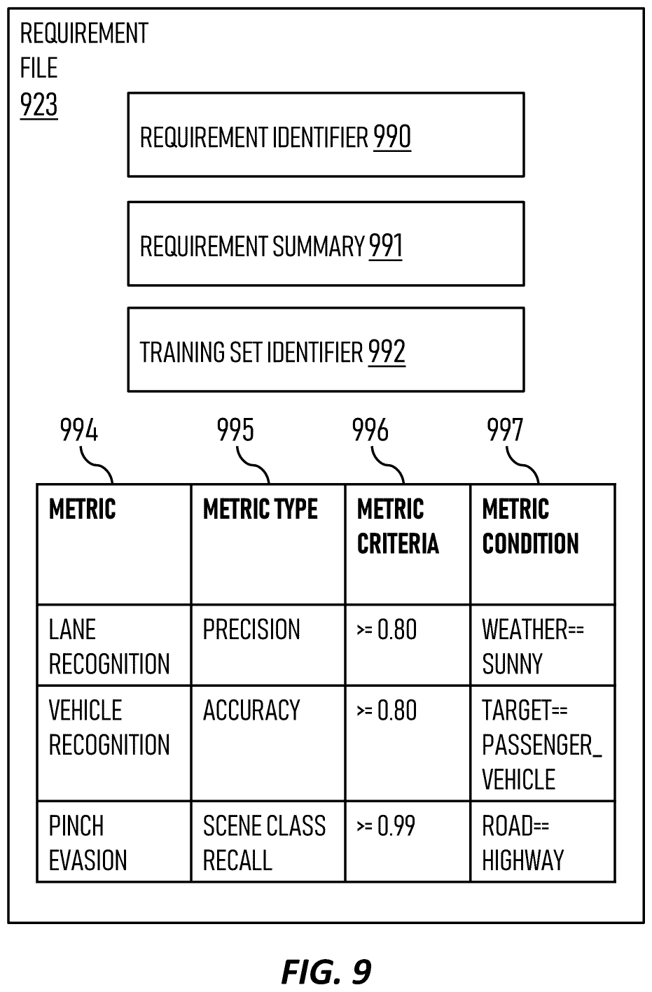

FIG. 9 is a schematic diagram of a requirement file, according to at least some embodiments of the subject disclosure. Requirement file 923 includes requirement identifier 990, requirement summary 991, training set identifier 992, and metrics 994. In at least some embodiments, requirement file 923 is the document that contains all the necessary information about the requirement, including the requirement identifier, summary, training set identifier, and metrics. In at least some embodiments, requirement file 923 includes structured data formatted in computer readable format, such as YAML format, JSON format, a protocol buffer, a text file, table data, machine-readable data, etc. In at least some embodiments, the requirement file contains compliance requirement details for a specific machine learning model, such as a vehicle application machine-learning model.

Requirement identifier 990 identifies requirement file 923. In at least some embodiments, requirement identifier 990 is a unique code that distinguishes requirement file 923 from other requirement files. In at least some embodiments, requirement identifier 990 is a unique alphanumeric string, such as “XYZ-1234”. In at least some embodiments, requirement identifier 990 is suitable as a search key for querying a requirement database.

Requirement summary 991 is a summary of requirement file 923. In at least some embodiments, requirement summary 991 provides a concise description of the vehicle application compliance requirement in requirement file 923. In at least some embodiments, requirement summary 991 includes background and context of the vehicle application compliance requirement in requirement file 923. In at least some embodiments, requirement summary 991 is a string of text, such as “Evasive action to avoid being pinched between trucks”. In at least some embodiments, requirement summary 991 includes a concrete example of one or more incidents.

Training set identifier 992 identifies training samples. In at least some embodiments, training set identifier 992 is a unique code that identifies a set of training samples used for training an applicable vehicle application machine-learning model to fulfill the vehicle application compliance requirement of requirement file 923. In at least some embodiments, training set identifier 992 is a unique alphanumeric string, such as “TRAINSET123456”, or metadata suitable for querying. In at least some embodiments, training set identifier 992 is a Uniform Resource Locator (URL).

Metrics 994 includes one or more metrics of requirement file 923. Each metric among metrics 994 includes metric type 995, metric criteria 996, and metric condition 997. In at least some embodiments, each metric among metrics 994 specifies a measure used to evaluate fulfillment of a vehicle application machine-learning model with a vehicle application compliance requirement defined in requirement file 923. In at least some embodiments, metric type 995 represents the type of metric. In at least some embodiments, metric type 995 is one of mean average precision (mAP), F1-score, precision, recall, accuracy, Jaccard, intersection over union (IoU), mean squared error (MSE), mean absolute error (MAE), etc. In at least some embodiments, metric criteria 996 outlines the standards used for the metric. In at least some embodiments, metric criteria 996 is a string or a numerical value, such as “>0.80”, “<0.80”, “=0.80”, “>=0.80”, “<=0.80”, etc. In at least some embodiments, metric condition 997 specifies a condition for testing the metric. In at least some embodiments, metric condition 997 narrows the scope of training samples used for testing metric criteria 996. In at least some embodiments, metric condition 997 is a string, such as “WEATHER==SUNNY”, “TARGET==PASSENGER VEHICLE”, “ROAD==HIGHWAY”etc.

FIG. 10 is a block diagram of a hardware configuration for continuous update of driving system for incident avoidance, according to at least some embodiments of the subject disclosure.

The exemplary hardware configuration includes server 1000, which interacts with input device 1007 and vehicle 1040 directly or through Internet 1009. In at least some embodiments, input device 1007 is a touch screen, a microphone, a camera, or any other device configured to detect tactile, aural, visual, etc. input. In at least some embodiments, Internet 1009 is an ethernet network, or any other wired or wireless network or a combination thereof. In at least some embodiments, server 1000 is a computer or other computing device that receives input or commands from input device 1007. In at least some embodiments, server 1000 is integrated with input device 1007. In at least some embodiments, server 1000 is a computer system that executes computer-readable instructions to perform operations for continuous update of driving system for incident avoidance.

Server 1000 includes a controller 1002, a storage 1004, an input/output interface 1006, and a communication interface 1008. In at least some embodiments, controller 1002 includes a processor or programmable circuitry executing instructions to cause the processor or programmable circuitry to perform operations according to the instructions. In at least some embodiments, controller 1002 includes analog or digital programmable circuitry, or any combination thereof. In at least some embodiments, controller 1002 includes physically separated storage or circuitry that interacts through communication. In at least some embodiments, storage 1004 includes a non-volatile computer-readable medium capable of storing executable and non-executable data for access by controller 1002 during execution of the instructions. In at least some embodiments, communication interface 1008 transmits and receives data from Internet 1009. In at least some embodiments, input/output interface 1006 connects to various input and output units, such as input device 1007, via a parallel port, a serial port, a keyboard port, a mouse port, a monitor port, and the like to accept commands and present information. In some embodiments, storage 1004 is external from server 1000.

Controller 1002 includes generating section 1002A, updating section 1002B, deploying section 1002C, and receiving section 1002D. Storage 1004 includes samples 1004A, requirement files 1004B, models 1004C, and logs 1004D.

Generating section 1002A is the circuitry or instructions of controller 1002 configured to generate vehicle application compliance requirements. In at least some embodiments, generating section 1002A is configured to define, by a requirement defining machine-learning model, a vehicle application compliance requirement according to an incident cluster among a plurality of incident clusters. In at least some embodiments, generating section 1002A utilizes information in storage 1004, such as samples 1004A and models 1004D, and records information in storage 1004, such as requirement files 1004B. In at least some embodiments, generating section 1002A includes sub-sections for performing additional functions, as described in the foregoing flow charts. In at least some embodiments, such sub-sections are referred to by a name associated with a corresponding function.

Updating section 1002B is the circuitry or instructions of controller 1002 configured to update a vehicle application machine-learning model. In at least some embodiments, updating section 1002B is configured to train a vehicle application machine-learning model with a first portion of the plurality of training samples. In at least some embodiments, updating section 1002B utilizes information in storage 1004, such as samples 1004A and requirement files 1004B, and records information in storage 1004, such as models 1004C. In at least some embodiments, updating section 1002B includes sub-sections for performing additional functions, as described in the foregoing flow charts. In at least some embodiments, such sub-sections are referred to by a name associated with a corresponding function.

Deploying section 1002C is the circuitry or instructions of controller 1002 configured to deploy a vehicle application machine-learning model. In at least some embodiments, deploying section 1002C is configured to deploy a vehicle application machine-learning model to a vehicle system in response to determining that the vehicle application machine-learning model fulfills the vehicle application compliance requirement. In at least some embodiments, updating section 1002B utilizes information in storage 1004, such as models 1004C. In at least some embodiments, deploying section 1002C includes sub-sections for performing additional functions, as described in the foregoing flow charts. In at least some embodiments, such sub-sections are referred to by a name associated with a corresponding function.

Receiving section 1002D is the circuitry or instructions of controller 1002 configured to receive application logs and other output logs. In at least some embodiments, receiving section 1002D is configured to receive an output log of the vehicle application machine-learning model from the vehicle system. In at least some embodiments, receiving section 1002D records information in storage 1004, such as logs 1004D. In at least some embodiments, receiving section 1002D includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, continuous update of driving system for incident avoidance is performed by collecting a plurality of incident samples from an Internet, the plurality of incident samples identified by an identification machine-learning model to involve one or more vehicles, clustering, by a clustering machine-learning model, the plurality of incident samples into a plurality of incident clusters, and defining, by a requirement defining machine-learning model, a vehicle application compliance requirement according to an incident cluster among the plurality of incident clusters.

In at least some embodiments, the defining the vehicle application compliance requirement includes defining a metric type, a metric criterion, and a metric evaluation condition. In at least some embodiments, continuous update of driving system for incident avoidance further includes preparing a plurality of training samples according to the vehicle application compliance requirement. In at least some embodiments, the preparing includes defining an annotation rule according to the vehicle application compliance requirement, labeling a plurality of sensor samples according to the annotation rule, and selecting the training samples from among the plurality of labeled sensor samples. In at least some embodiments, continuous update of driving system for incident avoidance further includes training a vehicle application machine-learning model with a first portion of the plurality of training samples. In at least some embodiments, continuous update of driving system for incident avoidance further includes testing the vehicle application machine-learning model with a second portion of the plurality of training samples according to the vehicle application compliance requirement. In at least some embodiments, continuous update of driving system for incident avoidance further includes determining whether the vehicle application machine-learning model fulfills the vehicle application compliance requirement. In at least some embodiments, continuous update of driving system for incident avoidance further includes deploying the vehicle application machine-learning model to a vehicle system in response to determining that the vehicle application machine-learning model fulfills the vehicle application compliance requirement. In at least some embodiments, continuous update of driving system for incident avoidance further includes receiving an output log of the vehicle application machine-learning model from the vehicle system, analyzing the output log to validate the vehicle application machine-learning model, and updating the vehicle application compliance requirement according to a result of the analyzing. In at least some embodiments, the vehicle application machine-learning model is configured for scene classification, the output log includes a plurality of scene classification results, and receiving the output log is in response to the vehicle application machine-learning model classifying a scene as a predetermined class. In at least some embodiments, the preparing includes receiving a sensor data log corresponding to the plurality of sensor samples. In at least some embodiments, the vehicle application compliance requirement includes a training set identifier. In at least some embodiments, continuous update of driving system for incident avoidance further includes assigning a priority value to each incident cluster among the plurality of incident clusters, wherein the defining is in response to determining that the priority value assigned to the incident cluster exceeds a threshold priority value. In at least some embodiments, the priority value is based on a size of the incident cluster. In at least some embodiments, the vehicle application compliance requirement is defined further according to constraints of a vehicle type. In at least some embodiments, the plurality of incident samples include natural language text. In at least some embodiments, the collecting includes applying the plurality of incident samples to a large language model. In at least some embodiments, the vehicle application compliance requirement includes structured data in a computer-readable format.

In at least some embodiments, continuous update of driving system for incident avoidance is performed by a processor executing instructions in accordance with the foregoing operations or a device comprising a controller including circuitry configured to perform the foregoing operations.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium having instructions recorded thereon that, in response to execution by one or more processors, cause performance of operations comprising:
collecting a plurality of incident samples from an Internet, the plurality of incident samples identified by an identification machine-learning model to involve one or more vehicles;
clustering, by a clustering machine-learning model, the plurality of incident samples into a plurality of incident clusters; and
defining, by a requirement defining machine-learning model, a vehicle application compliance requirement according to an incident cluster among the plurality of incident clusters.

2. The computer-readable medium of claim 1, wherein the defining the vehicle application compliance requirement includes defining
a metric type,
a metric criterion, and
a metric evaluation condition.

3. The computer-readable medium of claim 1, wherein the operations further comprise
preparing a plurality of training samples according to the vehicle application compliance requirement.

4. The computer-readable medium of claim 3, wherein the preparing includes defining an annotation rule according to the vehicle application compliance requirement, labeling a plurality of sensor samples according to the annotation rule, and selecting the training samples from among the plurality of labeled sensor samples.

5. The computer-readable medium of claim 4, wherein the operations further comprise
training a vehicle application machine-learning model with a first portion of the plurality of training samples.

6. The computer-readable medium of claim 5, wherein the operations further comprise
testing the vehicle application machine-learning model with a second portion of the plurality of training samples according to the vehicle application compliance requirement.

7. The computer-readable medium of claim 6, wherein the operations further comprise
determining whether the vehicle application machine-learning model fulfills the vehicle application compliance requirement.

8. The computer-readable medium of claim 7, wherein the operations further comprise
deploying the vehicle application machine-learning model to a vehicle system in response to determining that the vehicle application machine-learning model fulfills the vehicle application compliance requirement.

9. The computer-readable medium of claim 8, wherein the operations further comprise
receiving an output log of the vehicle application machine-learning model from the vehicle system,
analyzing the output log to validate the vehicle application machine-learning model, and
updating the vehicle application compliance requirement according to a result of the analyzing.

10. The computer-readable medium of claim 9, wherein
the vehicle application machine-learning model is configured for scene classification,
the output log includes a plurality of scene classification results, and
receiving the output log is in response to the vehicle application machine-learning model classifying a scene as a predetermined class.

11. The computer-readable medium of claim 4, wherein the preparing includes
receiving a sensor data log corresponding to the plurality of sensor samples.

12. The computer-readable medium of claim 1, wherein the vehicle application compliance requirement includes a training set identifier.

13. The computer-readable medium of claim 1, wherein the operations further comprise
assigning a priority value to each incident cluster among the plurality of incident clusters,
wherein the defining is in response to determining that the priority value assigned to the incident cluster exceeds a threshold priority value.

14. The computer-readable medium of claim 13, wherein the priority value is based on a size of the incident cluster.

15. The computer-readable medium of claim 1, wherein the vehicle application compliance requirement is defined further according to constraints of a vehicle type.

16. The computer-readable medium of claim 1, wherein the plurality of incident samples include natural language text.

17. The computer-readable medium of claim 1, wherein the collecting includes
applying the plurality of incident samples to a large language model.

18. The computer-readable medium of claim 1, wherein the vehicle application compliance requirement includes structured data in a computer-readable format.

19. A method comprising:
collecting a plurality of incident samples from an Internet, the plurality of incident samples identified by an identification machine-learning model to involve one or more vehicles;
clustering, by a clustering machine-learning model, the plurality of incident samples into a plurality of incident clusters; and
defining, by a requirement defining machine-learning model, a vehicle application compliance requirement according to an incident cluster among the plurality of incident clusters.

20. A device comprising:
a controller including circuitry configured to perform operations including
collecting a plurality of incident samples from an Internet, the plurality of incident samples identified by an identification machine-learning model to involve one or more vehicles,
clustering, by a clustering machine-learning model, the plurality of incident samples into a plurality of incident clusters, and
defining, by a requirement defining machine-learning model, a vehicle application compliance requirement according to an incident cluster among the plurality of incident clusters.
